(19) United States
(12) Patent Application Publication
(10) Pub. No.: US 2013/0318988 A1
(43) Pub. Date: Dec. 5, 2013

(54) AIRCRAFT ENGINE WITH TURBINE HEAT EXCHANGER BYPASS

(71) Applicant: MTU Aero Engines GmbH, (US)

(72) Inventor: Jerry C.J. Robinson, Nandlstadt (DE)

(73) Assignee: MTU Aero Engines GmbH, Muenchen (DE)

(21) Appl. No.: 13/800,434

(22) Filed: Mar. 13, 2013

(30) Foreign Application Priority Data
Mar. 16, 2012 (EP) 12001802.3
Jul. 10, 2012 (EP) 12005096.8

(51) Int. Cl. F02C 3/04

(52) U.S. Cl. CPC F02C 3/04
USPC 60/772; 60/726

(57) ABSTRACT

An aircraft engine, in particular a helicopter engine, having a one or multi-stage compressor system (V), a combustion chamber (BK) connected downstream therefrom, and a one- or multi-stage turbine system (HT, NT) connected downstream therefrom, a compressor heat exchanger system (WV), a turbine heat exchanger system (WT), and a bypass means for optionally guiding the working medium through or past at least one turbine heat exchanger (WT) of the turbine heat exchanger system.

This claims the benefit of European Patent Applications EP 12001802.3, filed Mar. 16, 2012 and EP 12005096.8, filed Jul. 10, 2012, both of which are hereby incorporated by reference herein.

The present invention relates to an aircraft engine, in particular a helicopter engine, as well as to a method for operating such an aircraft engine.

### BACKGROUND

Previous heat exchanger gas turbines are only of limited suitability, in particular due to the size of the heat exchangers designed for full-load operation, for use as aircraft engines, in particular as helicopter engines.

### SUMMARY OF THE INVENTION

It is an object of the present invention to advantageously operate an aircraft, in particular a helicopter.

The present invention provides that the working medium of the engine flows, optionally entirely or partially, through or bypasses a turbine heat exchanger system downstream from a turbine, the working medium being, in particular, understood as the fluid which flows through the combustion chamber.

In this way, it is possible to bypass the turbine heat exchanger system entirely or partially during an operating state, in particular during full-load, so that the turbine heat exchanger system does not have to be designed for great loads and mass flows, e.g., of the full-load operation. Accordingly, the turbine heat exchanger system and thus the aircraft engine may advantageously be designed in a more compact manner and is therefore, in particular, suitable for use as a helicopter engine. However, during another operating state, in particular during partial load, e.g., during pressure ratios which are smaller than 10:1, it is possible to “add” the turbine heat exchanger system, which is preferably compact and only designed for such partial load stresses and partial load mass flows, thus improving the operation of the aircraft engine. It is thus possible in one embodiment, depending on the operating state, to optionally make available two aircraft engines: an aircraft engine with a turbine heat exchanger system for partial loads and an aircraft engine without a turbine heat exchanger system for full loads.

According to one aspect of the present invention, an aircraft engine has a one- or multi-stage compressor system, a combustion chamber connected downstream therefrom, and a one- or multi-stage turbine system connected downstream therefrom.

The compressor system may, in particular, have one or multiple low-, medium-, and/or high-pressure compressor(s) or compressor stage(s), and the turbine system may have one or multiple high-, medium-, and/or low-pressure turbine(s) or turbine stage(s).

A heat exchanger of a compressor heat exchanger system may be situated upstream and/or downstream from one or multiple compressor stages, in particular between a compressor stage, which is last in the flow-through direction, and the combustion chamber. A heat exchanger of a turbine heat exchanger system may be situated upstream and/or downstream from one or multiple turbine stages, in particular downstream from a turbine stage, which is last in the flow-through direction, in order to exchange heat with the working medium of the aircraft engine. The compressor heat exchanger system and the turbine heat exchanger system, which together form an engine heat exchanger, communicate with one another, in particular via a flowing heat exchanger medium, in particular to transfer heat from the hotter working medium of the turbine system to the cooler working medium of the compressor system.

In one embodiment of the present invention, one, preferably the only one, heat exchanger of the compressor heat exchanger system is designed as a heat exchanger passage through which the working medium of the aircraft engine flows and which is configured in such a way that the working medium, which leaves a compressor stage of the compressor system which is, in particular, last in the flow-through direction, flows through partially, or at least essentially, entirely in order to absorb heat in the turbine heat exchanger system from the working medium which leaves the one turbine stage of the turbine system which is, in particular, last in the flow-through direction, and is subsequently preferably supplied to the combustion chamber as a heated working medium. In one embodiment, the heat exchanger medium may accordingly be the working medium in general, which has flowed through the compressor system, and the compressor heat exchanger system may be designed as an open heat exchanger. In one embodiment, the compressor heat exchanger system has an inlet which is configured in such a way that the working medium, which leaves a compressor stage of the compressor system which is, in particular, last in the flow-through direction, flows through this inlet partially, or at least essentially, entirely; the compressor heat exchanger system also has an outlet which is configured to supply this working medium to the combustion chamber after it has flowed through the heat exchanger passage. The heat exchanger passage between the inlet and the outlet may, in particular, have one or multiple, preferably parallel, tubes or tube segments.

According to one embodiment, a variable or adjustable bypass means is situated upstream from at least one heat exchanger of the turbine heat exchanger system in order to guide a portion of the working medium optionally past one or multiple, in particular all, heat exchanger(s) of the turbine heat exchanger system or to guide it through this/these heat exchanger(s).

The bypass means may, in particular, have one or multiple servo valve(s) in order to optionally, in particular entirely or partially, open and/or close a bypass passage and/or a working medium passage through the heat exchanger(s) of the turbine heat exchanger system.

According to one aspect of the present invention, the engine heat exchanger, in particular the compressor heat exchanger system and/or the turbine heat exchanger system, are not designed for a full-load operating state, but for an, in particular, relevant and definitive or main/partial load operating state in order to advantageously optimize the size, the weight, and/or the efficiency. This may also depend on the selected thermodynamic cycle.

In one preferred embodiment, at least 30%, in particular at least 50%, of the working medium, with regard to the mass or the volume flow, for example, are guided during at least one operating state, in particular during a full-load operating state, through the bypass passage or past the turbine heat exchanger system, in particular in such a way that the turbine may fully relax. In one refinement, less than 50%, in particular less than 30%, of the working medium are guided during at least one other operating state, in particular during a partial load operating state, through the bypass passage.

In one preferred embodiment, one or multiple compressor stages and/or turbine stages, in particular at least 30%, preferably at least 50%, of all compressor stages of the compressor system and/or at least 30%, preferably at least 50%, of all turbine stages of the turbine system, in particular of a core engine compressor, are designed to be variable or adjustable, in particular to enable preferably great variations of the compressor capacity, without a particularly large efficiency loss.

In one preferred embodiment, the aircraft engine, in particular the compressor and/or the turbine system, has stationary and/or moving blades which are designed to be variable or adjustable. These are preferably designed to allow a variation of the capacity around a nominal value which, in particular during load changes and/or transient processes, accounts for at least −30%, in particular at least −35%, and/or no more than +15%, in particular no more than +10%.

In one preferred embodiment, the aircraft engine has a high-pressure turbine or turbine stage having a variable capacity to change the thermodynamic throttling lines in the characteristic of the compressor system, in particular of a core engine compressor.

In one preferred embodiment, the thermodynamic cycle of the aircraft engine has an, in particular medium, pressure ratio which accounts for at least 5:1, in particular at least 10:1 and/or no more than 50:1, in particular no more than 20:1, in particular as a function of a predefined or required energy or power density, e.g., shaft power/engine weight, e.g., shp (shaft horsepower)/lb, for the application and the necessary basic cycle thermodynamic efficiency.

According to one aspect of the present invention, the engine is operated during the operation under stationary conditions and/or within the operating range within the operating limits, at the maximum combustor or combustion chamber discharge temperature and/or at the minimum mass flow for a predefined power output, while maximum efficiency levels are preferably kept in one or multiple components of the engine according to the best component matching for the cycle.

Additionally or alternatively, the bypass means may be operated in the case of high outputs, in particular full load, in such a way that the heat exchanger flow, heat exchanger loss, and heat exchanger efficiency correlation and the core engine cycle thermodynamic efficiency are or will be optimized.

Additionally or alternatively, one or multiple variable components may be changed or adjusted during transient operating states, in order to meet stability requirements, maximum rates of acceleration and/or temperature limits.

For this purpose, the aircraft engine may have a correspondingly configured control unit in one embodiment.

According to one aspect of the present invention, at least 30%, in particular at least 50%, of the working medium exiting the combustion chamber may be guided entirely or partially past the turbine heat exchanger system during at least one operating state, in particular during a full-load operating state. In one refinement, at least 30%, in particular at least 50%, of the working medium are guided at least partially past the turbine heat exchanger system, if the pressure ratio of the compressor system admission pressure and the turbine system discharge pressure is greater than 10:1, in particular greater than 12:1. Additionally or alternatively, at least 30%, in particular at least 50%, of the working medium may be guided entirely or partially through the turbine heat exchanger system, if the pressure ratio of the compressor system admission pressure and the turbine system discharge pressure is smaller than 10:1, in particular smaller than 8:1.

### BRIEF DESCRIPTION OF THE DRAWINGS

Other features and advantages result from the subclaims and the exemplary embodiments.

FIG. 1 shows an aircraft engine according to one embodiment of the present invention;

FIG. 2 shows a stepped characteristic;

FIG. 3 shows a specific fuel consumption;

FIG. 4 shows a pressure ratio;

FIG. 5 (a) shows a position of a bypass means BY,

(b) values W45R

(c) values Rbios

(d) values for the compressor;

FIG. 6 shows an overall compressor characteristic;

FIG. 7 shows a part of the aircraft engine of FIG. 1; and

FIG. 8 shows a specific fuel consumption.

### DETAILED DESCRIPTION

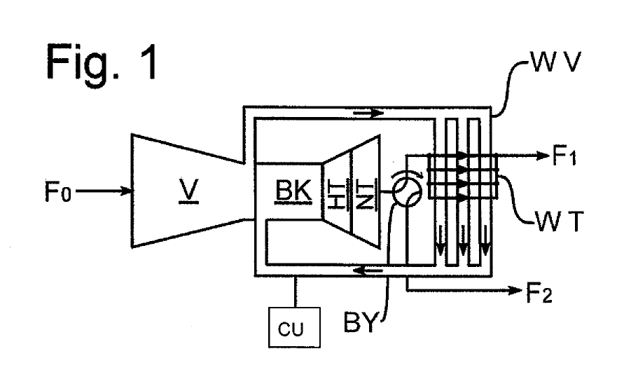

FIG. 1 shows an aircraft engine according to one embodiment of the present invention having a compressor V, a combustion chamber BK connected downstream therefrom, a high-pressure turbine or turbine stage HT connected downstream therefrom, and a low-pressure turbine or turbine stage NT connected downstream therefrom. The compressor takes in a working medium flow F₀.

A compressor heat exchanger WV, which communicates with a turbine heat exchanger WT situated downstream from the low-pressure turbine, is situated between the compressor and the combustion chamber.

Compressor heat exchanger WV is designed as an open heat exchanger having a heat exchanger passage into which the entire working medium, which leaves compressor V, enters through an inlet. During the flow through, this working medium, which is, as an example, in cross current in the exemplary embodiment, absorbs heat from the working medium, which leaves low-pressure turbine NT, and subsequently enters combustion chamber BK from a discharge. Three parallel tube segments of heat exchanger WV and four parallel tube segments of turbine heat exchanger WT are indicated as an example.

A variable bypass means BY may optionally open or close a bypass passage around turbine heat exchanger WT and thereby guide a working medium flow portion F₂ past turbine heat exchanger WT through which working medium flow portion F₁ flows. A control unit CU, shown schematically, actuates the bypass means in such a way that during at least one operating state, in particular during a full-load operating state, at least 50% of the working medium are guided through the bypass passage, so that turbine system HT, NT may fully relax. It is also possible, in particular during the full-load operation, to guide the entire working medium past turbine heat exchanger WT (F₁=0).

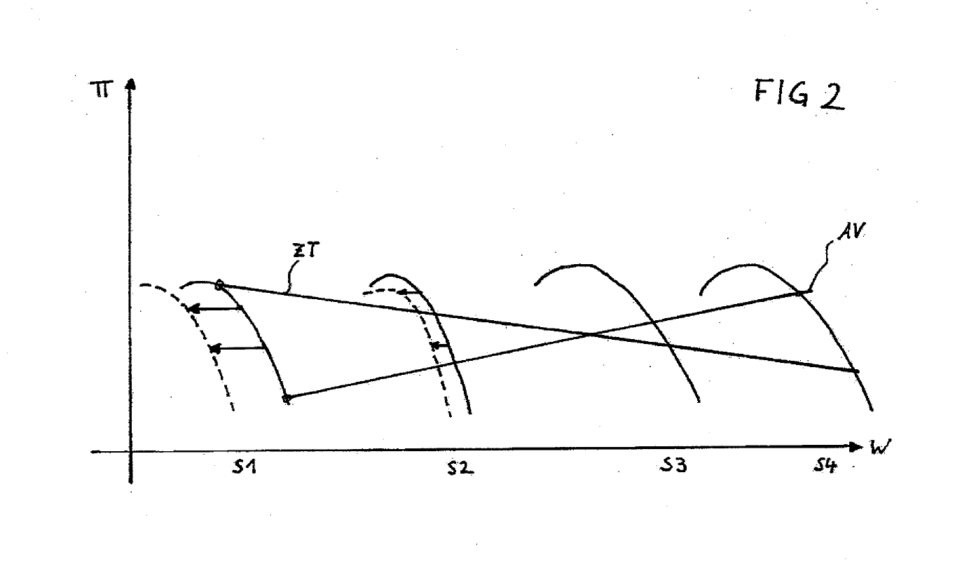

At least 50% of all compressor stages of compressor V, e.g., the two low-pressure stages S1, S2 (cf. FIG. 2) of a four-stage compressor, are designed to be variable or adjustable, e.g., with the aid of adjustable stationary and/or moving blades, adjustable bypass passages or the like which are actuated by the control unit.

FIG. 2 shows a stepped characteristic in which pressure ratio π is illustrated against flow rate W for the four stages S1, S2, S3 and S4 of compressor V, in particular of a core engine compressor. AV denotes the working points full load and ZT denotes the working points target partial load. Furthermore, the adjustments in the low-pressure compressor (stages S1, S2), in particular of its stator, are indicated with dotted lines.

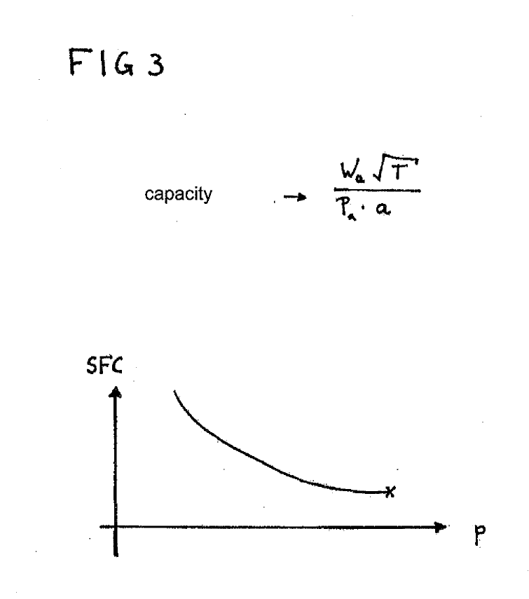

FIG. 3 shows, in particular for the turbine system, the specific fuel consumption (SFC) against pressure P, 0% (designed for maximum load) being marked by a cross (x).

The capacity results from the formula indicated in FIG. 3, T denoting the temperature, Pₐ the pressure, a the cross section, and W the flow rate.

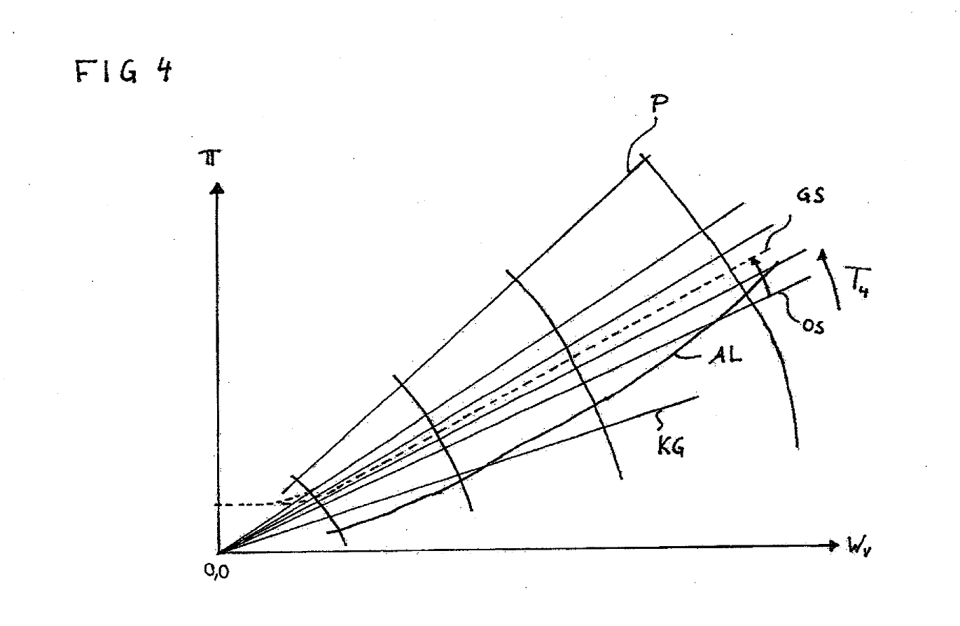

FIG. 4 shows pressure ratio π against flow rate W_{V}, in particular for a high-pressure turbine or turbine stage having a variable capacity. Pumping limit P, an open position OS, a closed position GS in which the stationary blades of high-pressure turbine or turbine stage HT are closed, a working line AL and throttling lines KG are illustrated in the drawing. A temperature increase of combustion chamber discharge temperature T₄ is indicated by an arrow.

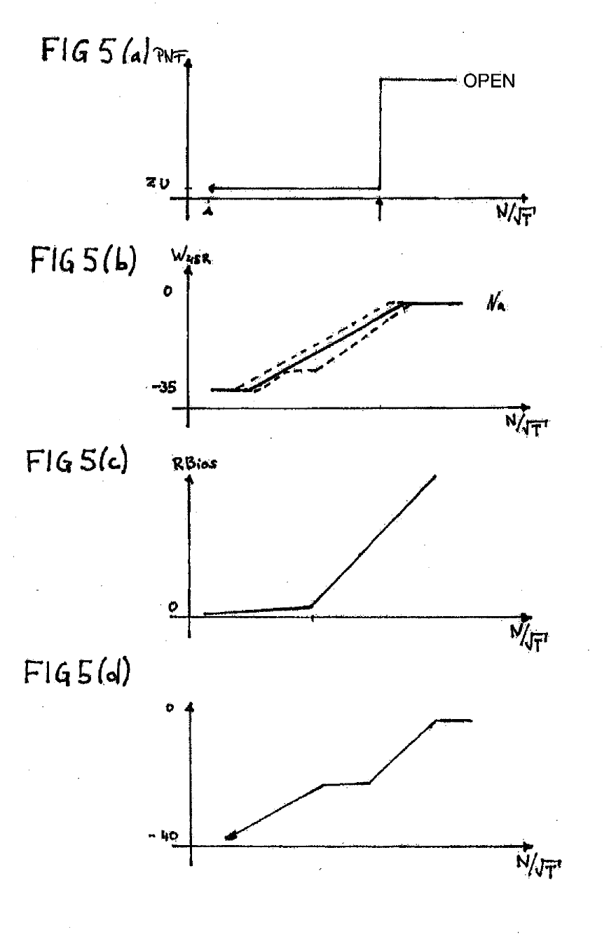

FIG. 5 shows (a) a position of bypass means BY (cf. FIG. 1), in particular of a bypass servo valve which is optionally adjustable between “CLOSED” and “OPEN,” (b) and (c) values W45R and Rbios, respectively, for the (power) turbine, as well as (d) for the compressor, each against speed parameter N/√T during an operation of the aircraft engine according to a method as recited in one embodiment of the present invention.

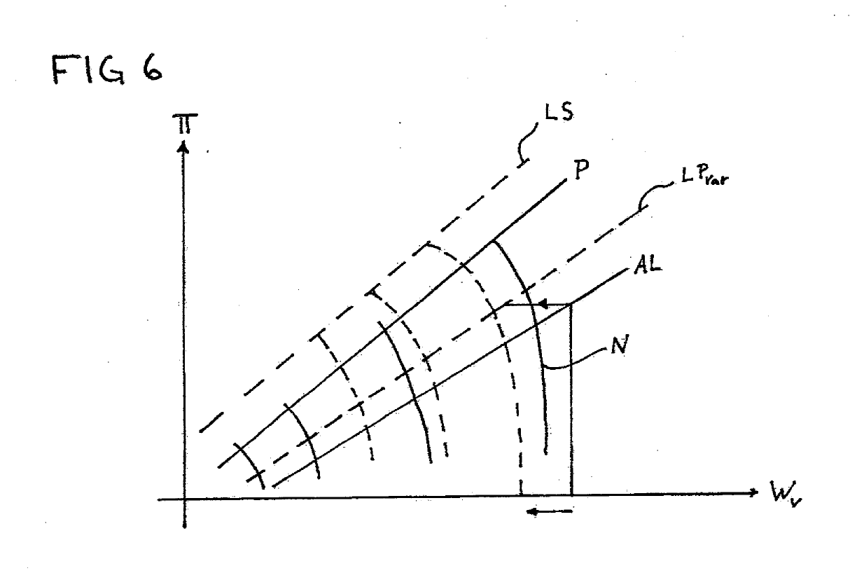

FIG. 6 shows the overall compressor characteristic having pressure ratio π against flow rate W_{V}. Stationary blades LS of the first stage of the variable compressor (dotted), pumping limit P, a working line AL, speed lines N, and variable low pressure LPᵥₐᵣ are marked.

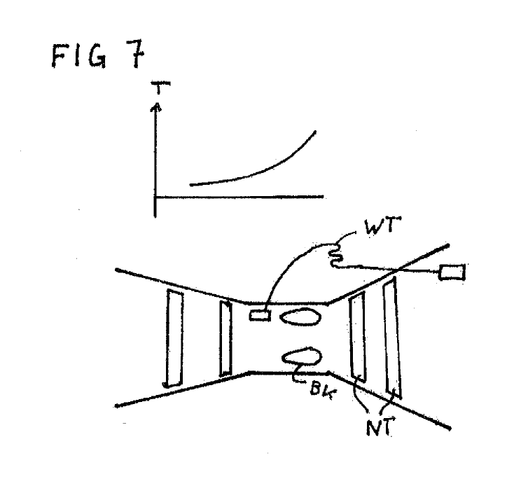

FIG. 7 shows an enlarged view of combustion chamber BK, variable or adjustable low-pressure turbine NT, and a part of turbine heat exchanger WT, temperature (difference) T being indicated in FIG. 7 above the aircraft engine.

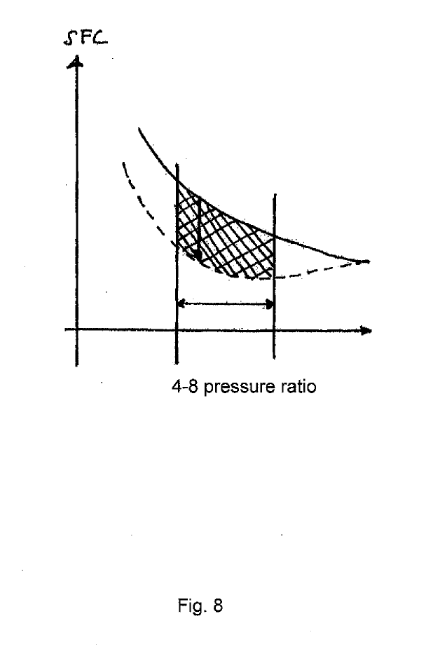

FIG. 8 shows the specific fuel consumption (SFC) against pressure or pressure ratio P, the design range for a heat exchanger being marked by vertical lines.

### LIST OF REFERENCE NUMERALS

F₀, F₁, F₂ working medium flow
V compressor
BK combustion chamber
HT high-pressure turbine/turbine stage
NT low-pressure turbine/turbine stage
BY (variable) bypass means
WT turbine heat exchanger
WV compressor heat exchanger
ZT target partial load
AV working point full load
AL working line
OS open position
GS closed position
P, Pₐ pressure (ratio)
KG throttling lines
T, T₄ temperature (difference)
N speed line
LS stationary blade
LPᵥₐᵣ variable low pressure
S1, S2, S3, S4 low-pressure stages
W, W_{V} flow rate
SFC specific fuel consumption
a cross section

What is claimed is:

1. An aircraft engine comprising:
a one- or multi-stage compressor system;
a combustion chamber connected downstream from the compressor system;
a one- or multi-stage turbine system connected downstream from the combustion chamber;
a compressor heat exchanger system;
a turbine heat exchanger system having at least one turbine heat exchanger; and
a bypass for optionally guiding the working medium through or past the at least one turbine heat exchanger.

2. The aircraft engine as recited in claim 1 wherein the compressor and/or the turbine heat exchanger system is/are designed for partial load operation.

3. The aircraft engine as recited in claim 1 wherein one or multiple stages of all stages of the compressor system and/or of the turbine system are designed to be adjustable.

4. The aircraft engine as recited in claim 3 wherein one or multiple stages of all stages of the compressor system and/or of the turbine system have adjustably designed stationary and/or moving blades.

5. The aircraft engine as recited in claim 3 wherein at least 30% of all of the stages of the compressor system and/or of the turbine system are designed to be adjustable.

6. The aircraft engine as recited in claim 3 wherein at least 50% of all of the stages of the compressor system and/or of the turbine system are designed to be adjustable.

7. The aircraft engine as recited in claim 1 wherein the turbine system includes a high-pressure turbine or turbine stage having a variable capacity.

8. The aircraft engine as recited in claim 1 further comprising having a control unit configured to guide a portion of a working medium exiting the combustion chamber past or through the turbine heat exchanger system.

9. A helicopter engine comprising the aircraft engine as recited in claim 1.

10. A method for operating an aircraft engine as recited in claim 1 comprising:
guiding at least 30% of a working medium exiting the combustion chamber past the turbine heat exchanger system during at least one operating state.

11. The method as recited in claim 10 wherein the guiding includes guiding at least 50% of the working medium.

12. The method as recited in claim 10 wherein the operating state is a full-load operating state.

13. The method as recited in claim 10 wherein the guiding occurs if a pressure ratio of the compressor system admission pressure and the turbine system discharge pressure is greater than 10:1.

14. The method as recited in claim 13 wherein the guiding occurs if the pressure ratio is greater than 12:1.

15. The method as recited in claim 1 comprising guiding at least 30% of the working medium through the turbine heat exchanger system.

16. The method as recited in claim 15 wherein the guiding includes guiding at least 50% of the working medium.

17. The method as recited in claim 15 wherein the guiding occurs if the pressure ratio of the compressor system admission pressure and the turbine system discharge pressure is smaller than 10:1.

18. The method as recited in claim 17 wherein the guiding occurs if the pressure ratio is smaller than 8:1.
